(19) United States
(12) Patent Application Publication
(10) Pub. No.: US 2013/0034095 A1
(43) Pub. Date: Feb. 7, 2013

(54) COMMUNICATION APPARATUS

(71) Applicant: Keiji MIYAZAKI, Kawasaki (JP)

(72) Inventor: Keiji MIYAZAKI, Kawasaki (JP)

(73) Assignee: FUJITSU LIMITED, Kawasaki-shi (JP)

(21) Appl. No.: 13/489,534

(22) Filed: Jun. 6, 2012

(30) Foreign Application Priority Data
Aug. 3, 2011 (JP) 2011-169755

(51) Int. Cl. H04L 12/28

(52) U.S. Cl. 370/389

(57) ABSTRACT

A communication apparatus includes a plurality of communication ports, a first memory unit, a second memory unit, and a processor. The second memory unit stores address information. Each entry of the address information includes an address of a node in association with one of the plurality of communication ports. The processor receives a message including an address of an incommunicable node via a receiving port which is one of the plurality of communication ports. The processor stores the received address in the first memory unit. The processor transmits the message via the plurality of communication ports other than the receiving port. The processor erases a target entry of the address information from the second memory unit after the transmission. The target entry includes an address which matches the address stored in the first memory unit.

### CROSS-REFERENCE TO RELATED APPLICATION

This application is based upon and claims the benefit of priority of the prior Japanese Patent Application No. 2011-169755, filed on Aug. 3, 2011, the entire contents of which are incorporated herein by reference.

### FIELD

The embodiments discussed herein are related to a communication apparatus.

### BACKGROUND

Communication apparatuses are conventionally used to relay communication between nodes in a network. A layer 2 (L2) switch that relays communication with a data link layer (second layer) of an Open Systems Interconnection (OSI) reference model is an example of a communication apparatus. A layer 3 (L3) switch that relays communication in a network layer (third layer) of the OSI reference model is another example of a communication apparatus.

A communication apparatus includes a learning function that learns a path in a network through which data is to be sent so that the data reaches the destination node. For example, an L2 switch includes a plurality of communication ports for connecting to cables. When transferring data, an L2 switch obtains a physical address of the node that is the transmission source of the data and saves the physical address in an address table in association with the communication port that has received the data. Subsequently, when the L2 switch receives data addressed to the physical address of the node, the L2 switch refers to the address table and sends that data from the port corresponding to the physical address. The L3 switch also has a similar learning function.

However, entries are occasionally erased from the address table. For example, it may occur when some type of failure has occurred in any other communication apparatus. In this case, the path that passes through the failed apparatus is unusable. Transmitting data to the unusable path is a wasteful process for a communication apparatus. Thus, it has been proposed that a communication apparatus conducts flooding of a control packet prompting erasure of information about the failed apparatus to cause other communication apparatuses to erase information about the failed apparatus from their address tables.

Also, all the information in the address table may be completely erased. For example, it may occur when a spanning tree is rebuilt in an Ethernet (trademark) network. In this case, erasing all the information may take much time if the number of entries in the address table is high. Thus, there is proposed a way to conduct the erasure of learned information in a short time by managing a table in which destination information (physical addresses) is stored in association with virtual transfer destination information grouped into types of the total amount or less of the destination information, and by managing a table in which the virtual transfer destination information is stored in association with transfer targets (ports).

Laid-open Patent Publication No. 2008-5458 and International Publication Pamphlet WO 2007/86539 disclose related techniques.

### SUMMARY

According to an aspect of the present invention, provided is a communication apparatus including a plurality of communication ports, a first memory unit, a second memory unit, and a processor. The second memory unit stores address information. Each entry of the address information includes an address of a node in association with one of the plurality of communication ports. The processor receives a message including an address of an incommunicable node via a receiving port which is one of the plurality of communication ports. The processor stores the received address in the first memory unit. The processor transmits the message via the plurality of communication ports other than the receiving port. The processor erases a target entry of the address information from the second memory unit after the transmission. The target entry includes an address which matches the address stored in the first memory unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary information processing system according to a first embodiment;

FIG. 2 illustrates an exemplary information processing system according to a second embodiment;

FIG. 3 is a block diagram illustrating an exemplary hardware configuration of a switch apparatus according to a second embodiment;

FIG. 4 is a block diagram illustrating an exemplary functional configuration of a switch apparatus according to a second embodiment;

FIG. 5 illustrates an exemplary flush message according to a second embodiment;

FIG. 6 illustrates an exemplary learning table according to a second embodiment;

FIG. 7 illustrates an exemplary failure MAC address table according to a second embodiment;

FIG. 8 is a flow chart illustrating processing upon failure detection according to a second embodiment;

FIG. 9 is a flow chart illustrating processing upon message reception according to a second embodiment;

FIG. 10 is a flow chart illustrating a learning table update process according to a second embodiment;

FIG. 11 illustrates an exemplary learning table update process according to a second embodiment;

FIG. 12 is a sequence diagram illustrating an exemplary message transmission according to a second embodiment;

FIG. 13 is a sequence diagram illustrating an exemplary message transmission according to a second embodiment;

FIG. 14 is a flow chart illustrating a learning table update process according to a third embodiment;

FIG. 15 is a sequence diagram illustrating an exemplary message transmission according to a third embodiment;

FIG. 16 is a flow chart illustrating an aging management process according to a third embodiment;

FIG. 17 illustrates an exemplary flush message according to a fourth embodiment;

FIG. 18 illustrates an exemplary failure MAC address table according to a fourth embodiment; and

FIG. 19 is a flow chart illustrating processing to determine a processing method according to a fourth embodiment; and.

FIG. 20 illustrates an exemplary system configuration of a computer.

### DESCRIPTION OF EMBODIMENTS

The transmission of the information (message) prompting update (erasure of entries) of the address table to each communication apparatus may be delayed. For example, it may occur when a communication apparatus conducts flooding of such a message after updating the address table. In this case, the flooding conducted by the communication apparatus may be delayed by the amount of time taken to carry out the table update. The delay in the flooding may be accumulated if there is a plurality of communication apparatuses. The transmission delay in terminal communication apparatuses becomes especially noticeable in very large networks.

This type of delay may be a factor that adversely affects communication efficiency. For example, when the transmission of the message prompting erasure of information about the failed apparatus is delayed, a communication apparatus may more likely to transmit data on the unusable path.

Hereinbelow, embodiments will be described with reference to the drawings.

### First Embodiment

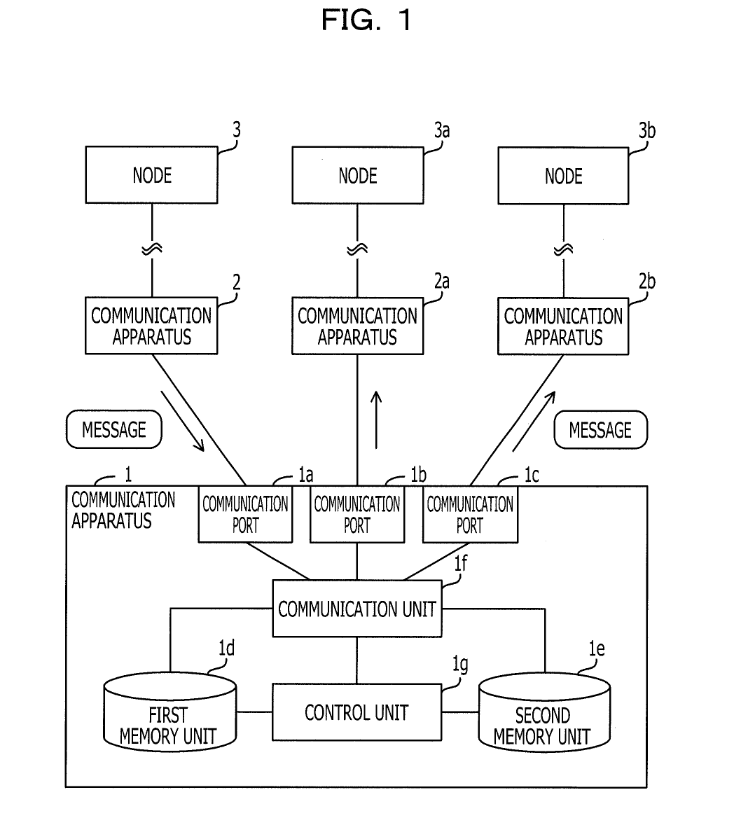

FIG. 1 illustrates an exemplary information processing system according to a first embodiment. The information processing system includes communication apparatuses 1, 2, 2a, and 2b, and nodes 3, 3a, and 3b. A node is a communication apparatus, an information processing apparatus, or the like. Specifically, a node is a router apparatus that conducts network routing, an L3 switch apparatus, a server apparatus, or the like.

The communication apparatuses 1, 2, 2a, and 2b relay communications between the nodes 3, 3a, and 3b. The communication apparatuses 1, 2, 2a, and 2b are, for example, L2 switch apparatuses, router apparatuses, L3 switch apparatuses, or the like. The communication apparatus 1 is connected to the communication apparatuses 2, 2a, and 2b. The communication apparatus 2 is connected to a transmission line to the node 3. The communication apparatus 2a is connected to a transmission line to the node 3a. The communication apparatus 2b is connected to a transmission line to the node 3b.

The communication apparatus 1 includes communication ports 1a, 1b, and 1c, a first memory unit 1d, a second memory unit 1e, a communication unit 1f, and a control unit 1g.

The communication ports 1a, 1b, and is are interfaces for connecting to the communication apparatuses 2, 2a, and 2b. The communication port 1a is connected to the communication apparatus 2 via a certain cable. The communication port 1b is connected to the communication apparatus 2a via a certain cable. The communication port 1c is connected to the communication apparatus 2b via a certain cable.

The first memory unit 1d stores an address included in a certain message received by the communication unit 1f.

The second memory unit 1e stores address information. Entries of the address information include addresses of the nodes 3, 3a, and 3b in association with the communication ports 1a, 1b, and 1c, respectively. The addresses of the nodes 3, 3a, and 3b are, for example, physical addresses of the nodes. Specifically, media access control (MAC) addresses may be used. For example, an address of the node 3 and the communication port 1a are associated with each other in the address information. For example, an address of the node 3a and the communication port 1b are associated with each other in the address information. For example, an address of the node 3b and the communication port 1c are associated with each other in the address information.

The communication unit 1f receives from any of the communication apparatuses 2, 2a, and 2b a message that includes an address of a node, for which communication has failed, among the nodes 3, 3a, and 3b. The communication unit 1f stores the address included in the message in the first memory unit 1d. For example, the communication unit 1f receives from the communication apparatus 2a message that includes an address of the node 3. The communication unit 1f then stores the address of the node 3 in the first memory unit 1d. The communication unit 1f transmits the message from all the communication ports except from the communication port that received the message. For example, the communication unit 1f transmits the message from the communication ports 1b and is when the message has been received by the communication port 1a. In this way, the message is reported to the other communication apparatuses 2a and 2b and the communication apparatuses 2a and 2b transmits the message similarly. Thus, the message is transmitted in a chain reaction to all the communication apparatuses in the network.

For example, when any one of the communication apparatuses detects a node that has failed in communication, the communication apparatus that has detected the failure creates a message. For example, when the communication apparatus 2 detects that a failure has occurred on a path to the node 3 and the path becomes unusable, the communication apparatus 2 creates a message to prompt erasure of an entry related to the address of the node 3 and transmits the message to the communication apparatus 1 (or to communication apparatuses including the communication apparatus 1).

The control unit 1g erases an entry of the address information which includes the address stored in the first memory unit 1d from the second memory unit 1e after the communication unit 1f has transmitted the message. For example, when the address stored in the first memory unit 1d is the address of the node 3, the control unit 1g erases an entry including the address of the node 3 in association with the communication port 1a from the address information stored in the second memory unit 1e after the communication unit 1f has transmitted the message.

According to the communication apparatus 1, the communication unit 1f receives a message that includes an address of a node, among the nodes 3, 3a, and 3b, for which communication has failed. The communication unit 1f stores the address in the first memory unit 1d and transmits the message from all the communication ports except from the one that has received the message. The control unit 1g erases an entry of the address information which includes the address stored in the first memory unit 1d from the second memory unit 1e after the communication unit 1f has transmitted the message.

As a result, delays in transmitting messages may be reduced. Specifically, the communication apparatus 1 updates the address information held therein after transmitting the message received from the communication apparatus 2 to other communication apparatuses. In this way, the message may be transmitted more quickly in comparison to transmitting the message after conducting the update of the address information.

In particular, if there are many entries in the address information, processing to erase the entries may take much time. In this case, the delay in transmitting the message is large. However, with the method conducted by the communication apparatus 1, the transmission of the message is conducted without waiting for the erasure process and thus the delay in transmission may be reduced.

Very large networks may be connected to a multitude of communication apparatuses. In this case, transmission of a message from a communication apparatus to the final communication apparatus may take a large amount of time. For example, when the message is transmitted after each communication apparatus has updated the address information, the delays in transmission of the message from each communication apparatus are accumulated and the delay until the message reaches the final communication apparatus becomes especially noticeable. In comparison, the delay in transmission of the message to each communication apparatus may be effectively reduced if the communication apparatuses on the network update the address information held therein after transmitting the message in the same way as the communication apparatus 1.

Multiple processing methods to update the address information in the communication apparatus 1 may be considered. For example, a processing method in which the address information is updated at a timing immediately after transmitting the message may be considered. Moreover, a processing method in which, for example, the address information is updated at a timing in which data destined to the destination address included in the message is relayed after transmitting the message may be considered.

Furthermore, the communication apparatus 1 may determine whether to use either of the processing methods to update the address information according to the received message. For example, when the message includes timing information that indicates a timing to conduct update of the address information, the communication apparatus 1 may determine to conduct update of the address information with either of the processing methods based on the timing information.

### Second Embodiment

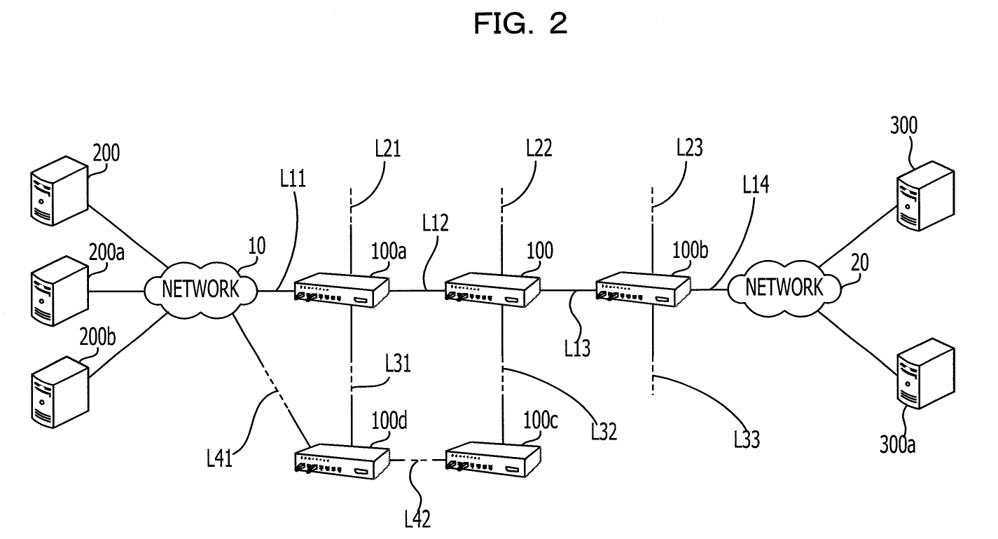

FIG. 2 illustrates an exemplary information processing system according to a second embodiment. The information processing system is constructed with a network based on Ethernet. The information processing system includes networks 10 and 20, switch apparatuses 100, 100a, 100b, 100c, and 100d, and server apparatuses 200, 200a, 200b, 300, and 300a. The information processing system includes paths L11, L12, L13, L14, L21, L22, L23, L31, L32, L33, L41, and L42 that connect the networks 10 and 20 and the switch apparatuses 100, 100a, 100b, 100c, and 100d. An apparatus connected to one end of each of the paths L21, L22, L23, and L33 is omitted in the drawing.

The paths L11, L12, L13, and L14 are signal transmission lines formed with local area network (LAN) cables. The paths L11, L12, L13, and L14 may also be formed with both LAN cables and other communication apparatuses (such as L2 switch apparatuses and L3 switch apparatuses).

The paths L21, L22, L23, L31, L32, L33, L41, and L42 are signal transmission lines formed with both LAN cables and other communication apparatuses. The paths L21, L22, L23, L31, L32, L33, L41, and L42 may also be formed with LAN cables.

The switch apparatuses 100, 100a, 100b, 100c, and 100d are L2 switch apparatuses that relay Ethernet frames (hereinbelow, referred to simply as “frames”) using OSI reference model layer 2. L2 switch apparatuses may also be called switching hubs.

The switch apparatus 100 is connected to the switch apparatus 100a via the path L12. The switch apparatus 100 is connected to the switch apparatus 100b via the path L13. The switch apparatus 100 is connected to the path L22. The switch apparatus 100 is connected to the switch apparatus 100c via the path L32.

The switch apparatus 100a is connected to the network 10 via the path L11. The switch apparatus 100a is connected to the switch apparatus 100 via the path L12. The switch apparatus 100a is connected to the path L21. The switch apparatus 100a is connected to the switch apparatus 100d via the path L31.

The switch apparatus 100b is connected to the switch apparatus 100 via the path L13. The switch apparatus 100b is connected to the network 20 via the path L14. The switch apparatus 100b is connected to the paths L23 and L33.

The switch apparatus 100c is connected to the switch apparatus 100 via the path L32. The switch apparatus 100c is connected to the switch apparatus 100d via the path L42.

The switch apparatus 100d is connected to the switch apparatus 100a via the path L31. The switch apparatus 100d is connected to the network 10 via the path L41. The switch apparatus 100d is connected to the switch apparatus 100c via the path L42.

LAN cable plugs are joined to the communication ports include in each of the switch apparatuses 100, 100a, 100b, 100c, and 100d such that the switch apparatuses 100, 100a, 100b, 100c, and 100d are connected to the paths. In the following description, the communication ports are simply referred to as ports.

The server apparatuses 200, 200a, 200b, 300, and 300a are information processing apparatuses that conduct certain information processing. The server apparatuses 200, 200a, and 200b are connected to the network 10. The server apparatuses 300 and 300a are connected to the network 20. Frames may be transmitted and received between the server apparatuses 200, 200a, 200b, 300, and 300a in the information processing system.

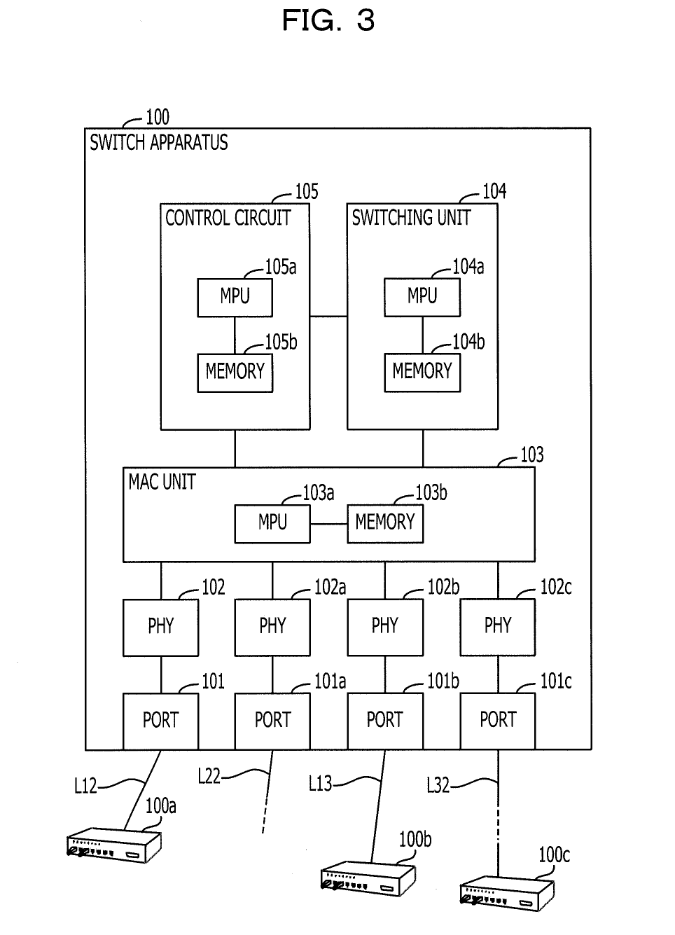

FIG. 3 is a block diagram illustrating an exemplary hardware configuration of a switch apparatus according to the second embodiment. A switch apparatus 100 has ports 101, 101a, 101b, and 101c, physical layer units (PHYs) 102, 102a, 102b, and 102c, a MAC unit 103, a switching unit 104, and a control circuit 105.

The ports 101, 101a, 101b, and 101c are adapters each equipped with a connector, e.g. a registered jack-45 (RJ-45), for linking with a plug provided at an end of a LAN cable, and a pulse transformer for terminating a signal. The port 101 is connected to a LAN cable on the path L12. The port 101a is connected to a LAN cable on the path L22. The port 101b is connected to a LAN cable on the path L13. The port 101c is connected to a LAN cable on the path L32. The ports 101, 101a, 101b, and 101c output received signals to the PHYs 102, 102a, 102b, and 102c, respectively. The ports 101, 101a, 101b, and 101c also transmit signals received from the PHYs 102, 102a, 102b, and 102c to the paths L12, L22, L13, and L32, respectively.

The PHYs 102, 102a, 102b, and 102c encode frames and decode signals. The PHY 102 is connected to the port 101 and the MAC unit 103. The PHY 102a is connected to the port 101a and the MAC unit 103. The PHY 102b is connected to the port 101b and the MAC unit 103. The PHY 102c is connected to the port 101c and the MAC unit 103.

The PHY 102 encodes frames outputted by the MAC unit 103 and outputs the encoded frames to the port 101. The PHY 102 decodes signals outputted by the port 101 to obtain data and outputs the obtained data to the MAC unit 103. Encoding methods used by the PHY 102 may include, for example, the non-return to zero (NRZ) encoding method, the Multi-Level Transmission-3 (MLT-3) encoding method, or the Manchester encoding method. Operations of the PHY 102a, the PHY 102b, and the PHY 102c are similar to the PHY 102.

The MAC unit 103 conducts media access control. The MAC unit 103 is connected to the PHYs 102, 102a, 102b, and 102c, the switching unit 104, and the control circuit 105. The MAC unit 103 controls transmission of frames outputted by the switching unit 104 to a network by using, for example, the Carrier Sense Multiple Access with Collision Detection (CSMA/CD) procedure. The MAC unit 103 includes a micro processing unit (MPU) 103a and a memory 103b.

The MPU 103a is a computing device that controls the entire MAC unit 103. The memory 103b is a storage device for storing data and programs used in the processing by the MPU 103a.

The switching unit 104 determines (switching) to which port to transmit frames received from the MAC unit 103 so as to send the frames to a destination node. The switching unit 104 includes an MPU 104a and a memory 104b.

The MPU 104a is a computing device that controls the entire switching unit 104. The memory 104b is a storage device for storing data and programs used in the processing by the MPU 104a.

The control circuit 105 is connected to the MAC unit 103 and the switching unit 104. The control circuit 105 creates control messages and outputs the messages to the MAC unit 103. The control circuit 105 processes control messages received from the MAC unit 103. The control circuit 105 executes processing based on the received messages. The control circuit 105 includes an MPU 105a and a memory 105b.

The MPU 105a is a computing device that controls the entire control circuit 105. The memory 105b is a storage device for storing data and programs used in the processing by the MPU 105a.

The switch apparatuses 100a, 100b, 100c, and 100d may be realized with hardware similar to that of the switch apparatus 100.

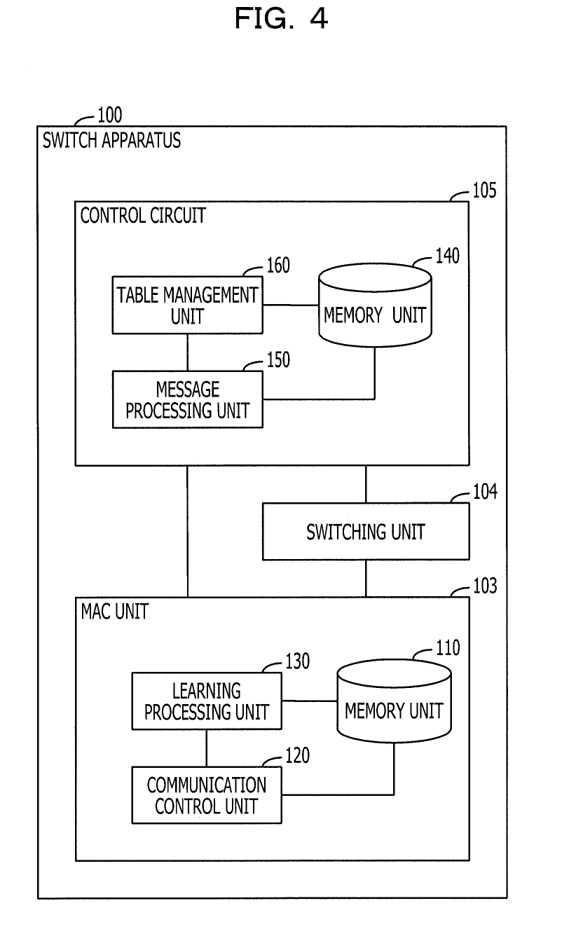

FIG. 4 is a block diagram illustrating an exemplary functional configuration of a switch apparatus according to the second embodiment. The switch apparatus 100 includes memory units 110 and 140, a communication control unit 120, a learning processing unit 130, a message processing unit 150, and a table management unit 160. The functions of the communication control unit 120 and the learning processing unit 130 are implemented by the MPU 103a by executing certain programs. The functions of the message processing unit 150 and the table management unit 160 are implemented by the MPU 105a by executing certain programs. However, the functions of the communication control unit 120, the learning processing unit 130, the message processing unit 150, and the table management unit 160 may also be implemented with dedicated hardware.

The memory unit 110 stores a learning table. Each entry of the learning table includes a source MAC address, which is included in a received frame, in association with the port that has received the frame. The learning table is created by the learning processing unit 130. The switching unit 104 references the learning table when transmitting a frame. The switching unit 104 determines, in accordance with the learning table stored in the memory unit 110, a port via which the frame is transmitted.

The communication control unit 120 conducts media access control. The communication control unit 120 controls transmission of frames to a network by using the CSMA/CD procedure. The switching unit 104 specifies a port to which the frame is transmitted The switching unit 104 instructs the communication control unit 120 to conduct flooding of the frame when no entry including the destination MAC address of the frame exists in the learning table.

The communication control unit 120 outputs a received frame and a control message to the control circuit 105. The communication control unit 120 also conducts flooding of a received control message to ports other than the receiving port that has received the message. The communication control unit 120 conducts flooding of a control message, which is created by the control circuit 105, to all the ports.

The learning processing unit 130 extracts a source MAC address included in a header of a frame upon receiving the frame. The learning processing unit 130 sets an entry including the extracted source MAC address in association with identification information (port ID) of the receiving port that has received the frame in the learning table. When an entry including the source MAC address already exists in the learning table, the learning processing unit 130 may keep the previously set entry and not register a new entry. Namely, the learning processing unit 130 prioritizes previously arrived settings.

The memory unit 140 stores a failure MAC address table. The failure MAC address table retains MAC addresses to be erased from the learning table. The failure MAC address table may be referred to as a failure address table in the following description.

The message processing unit 150 creates a control message and outputs the created control message to the MAC unit 103. The message processing unit 150 extracts information included in control messages obtained from the MAC unit 103, and stores the extracted information in the memory unit 140. The control messages include a flush message prompting erasure of an entry of the learning table. A flush message is a control message that prompts erasure of an entry including a certain MAC address. A flush message includes a MAC address to be erased.

For example, the message processing unit 150 extracts a MAC address included in a flush message received from another switch apparatus and stores the extracted MAC address in the memory unit 140. At this time, the message processing unit 150 stores the MAC address in the memory unit 140 in association with a port ID of the receiving port that has received the flush message.

For example, when a failure occurs that makes any of the paths L12, L22, L13, and L32 unusable, the message processing unit 150 creates a flush message that includes a MAC address corresponding to the port on that failed path and outputs the flush message to the MAC unit 103. The message processing unit 150 determines the MAC address corresponding to the port on the failed path based on the learning table stored in the memory unit 110. The message processing unit 150 may, for example, detect the failure on the path by detecting link down of a port.

Hereinbelow, the flush message may be described as simply a message in the following description.

The table management unit 160 erases an entry of the learning table stored in the memory unit 110 based on the failure MAC address table stored in the memory unit 140.

The switch apparatuses 100a, 100b, 100c, and 100d are equipped with similar functions to those of the switch apparatus 100.

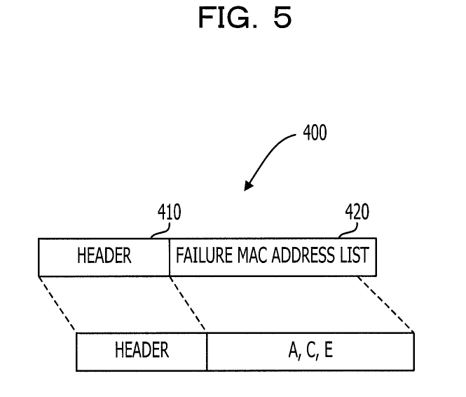

FIG. 5 illustrates an exemplary flush message according to the second embodiment. A flush message 400 includes fields of a header 410 and a failure MAC address list 420.

The header 410 is a field that stores information used for transmission control. For example, the header 410 includes information indicating that the flush message 400 is a message for erasing an entry of the learning table. For example, the header 410 includes a destination MAC address and a source MAC address. The destination MAC address is set with “FF:FF:FF:FF:FF:FF” since the flush message 400 is broadcasted.

The failure MAC address list 420 includes MAC addresses to be erased. For example, it is assumed that the switch apparatus 100a detects a failure on the path L11. In this case, the switch apparatus 100a creates the flush message 400 and floods the flush message 400 to the paths L12, L21, and L31. The switch apparatus 100a sets the MAC addresses of the server apparatuses 200, 200a, and 200b connected to the path L11 in the failure MAC address list 420.

In the following description, the MAC address of a network interface card (NIC) in the server apparatus 200 is abbreviated as “A”. The MAC address of an NIC in the server apparatus 200a is abbreviated as “C”. The MAC address of an NIC in the server apparatus 200b is abbreviated as “E”. The MAC address of an NIC in the server apparatus 300 is abbreviated as “B”. The MAC address of an NIC in the server apparatus 300a is abbreviated as “D”.

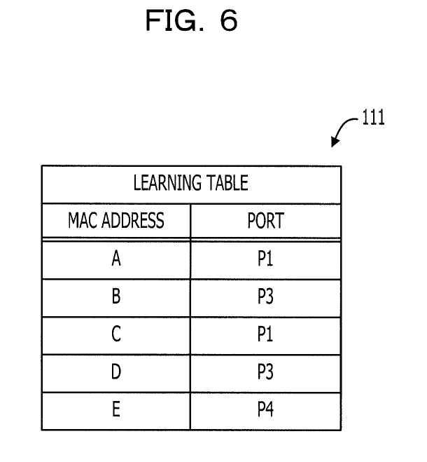

FIG. 6 illustrates an exemplary learning table according to the second embodiment. A learning table 111 is stored in the memory unit 110. The learning table 111 is provided with headings for a MAC address and a port. Information arranged in a horizontal direction is associated with each other to form an entry corresponding to one path.

A MAC address is set under the MAC address heading. A port ID is set under the port heading.

For example, an entry including a MAC address “A” and a port ID “P1” is set in the learning table 111. This entry indicates that a frame to be transmitted to the server apparatus 200 corresponding to the MAC address “A” may be transmitted from a port identified by the port ID “P1”.

Here, “P1” is a port ID of the port 101. “P2” is a port ID of the port 101a. “P3” is a port ID of the port 101b. “P4” is a port ID of the port 101c.

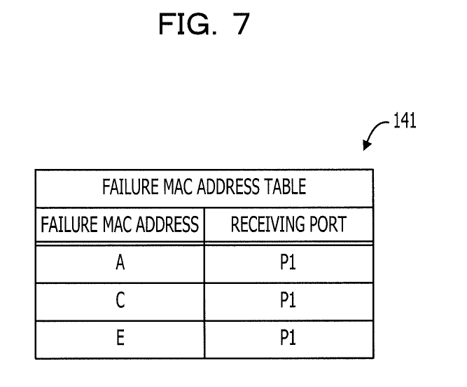

FIG. 7 illustrates an exemplary failure MAC address table according to the second embodiment. A failure MAC address table 141 is stored in the memory unit 140. The failure MAC address table 141 is provided with headings for a failure MAC address and a receiving port. Information arranged in a horizontal direction is associated with each other to form an entry corresponding to one node.

A MAC address to be erased is set under the failure MAC address heading. Hereinbelow, MAC addresses set in the failure MAC address table 141 and the failure MAC address list 420 may be referred to as failure MAC addresses. A port ID of a port that has received a flush message including the MAC address is set under the receiving port heading.

The failure MAC address table 141 illustrates a case in which the switch apparatus 100 receives the flush message 400 from the switch apparatus 100a through the path L12. MAC addresses “A”, “C”, and “E” are set in the failure MAC address list 420 of the flush message 400. In this example, an entry including a failure MAC address “A” and a receiving port ID “P1” is set in the failure MAC address table 141. An entry including a failure MAC address “C” and a receiving port ID “P1” is also set in the failure MAC address table 141. Furthermore, an entry including a failure MAC address “E” and a receiving port ID “P1” is also set in the failure MAC address table 141.

The following is a description of operating procedures of an information processing system with the above configuration. The processing upon failure detection will be described first. It is assumed herein that a failure occurs on the path L11 and the switch apparatus 100a detects the failure.

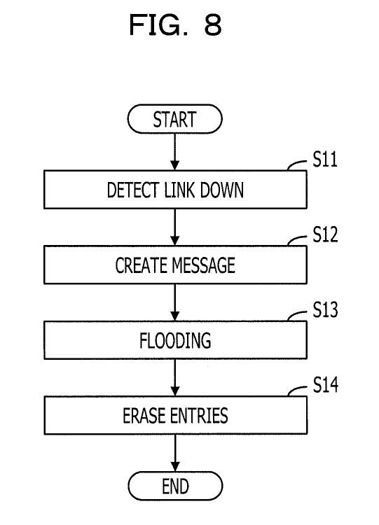

FIG. 8 is a flow chart illustrating processing upon failure detection according to the second embodiment. The processing illustrated in FIG. 8 will be described.

In S11, the switch apparatus 100a detects a link down of a port connected to the path L11.

In S12, the switch apparatus 100a creates the flush message 400. In this time, the switch apparatus 100a searches the learning table retained therein by a port ID of a port on the path L11 to extract MAC addresses corresponding to the port ID. The switch apparatus 100a sets the extracted MAC addresses “A”, “C”, and “E” in the failure MAC address list 420.

In S13, the switch apparatus 100a conducts flooding of the flush message 400 to ports on the paths L12, L21, and L31.

In S14, the switch apparatus 100a erases the entries including the MAC addresses extracted in S12 from the learning table retained therein.

In this way, the switch apparatus 100a obtains, upon detecting a link down of a port, MAC addresses corresponding to the port, creates the flush message 400, and conducts flooding. As a result, other communication apparatuses are prompted to erase their entries including the MAC addresses. Since the switch apparatus 100a erases the entries of the learning table retained therein after conducting the flooding, the transmission of the flush message 400 may be initiated more quickly.

Next, the operating procedures of the switch apparatus 100 that has received the flush message 400 will be described.

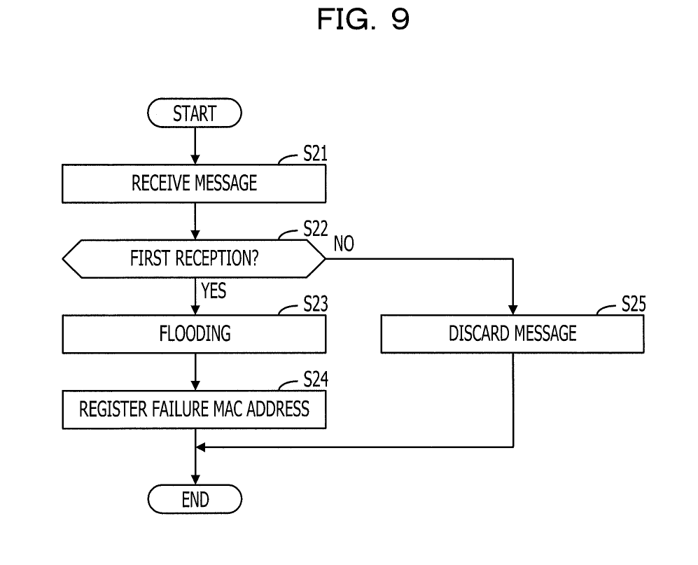

FIG. 9 is a flow chart illustrating processing upon message reception according to the second embodiment. The processing illustrated in FIG. 9 will be described.

In S21, the communication control unit 120 receives the flush message 400 via the path L12 from the switch apparatus 100a, and outputs the received flush message 400 to the message processing unit 150. The port that has received the flush message 400 in this case is the port 101 (port ID “P1”).

In S22, the message processing unit 150 determines whether or not the reception of the flush message 400 is the first reception. The message processing unit 150 may determine whether or not the reception is the first reception by, for example, referring to the failure MAC address table 141 stored in the memory unit 140 to determine whether or not the MAC address in the failure MAC address list 420 of the flush message 400 has been registered. The message processing unit 150 determines that the reception is the first reception when the MAC address is not registered. The message processing unit 150 determines that the reception is the second or subsequent reception when the MAC address is already registered. The processing advances to S23 when the reception is the first reception. The processing advances to S25 when the reception is the second or subsequent reception.

In S23, the communication control unit 120 floods the received flush message 400 to the ports 101a, 101b, and 101c.

In S24, the message processing unit 150 sets, in the failure MAC address table 141, an entry including the MAC address included in the failure MAC address list 420 of the flush message 400 in association with the port ID “P1” of the port 101 that is the receiving port. The processing is then completed.

In S25, the message processing unit 150 discards the received flush message 400. In this case, the communication control unit 120 does not flood the flush message 400. The processing is then completed.

In this way, the switch apparatus 100 conducts flooding upon receiving the flush message 400. The switch apparatus 100 registers the MAC address included in the flush message 400 to the failure MAC address table 141 in association with the receiving port.

The switch apparatus 100 updates (entry erasure) the learning table 111 stored in the memory unit 110.

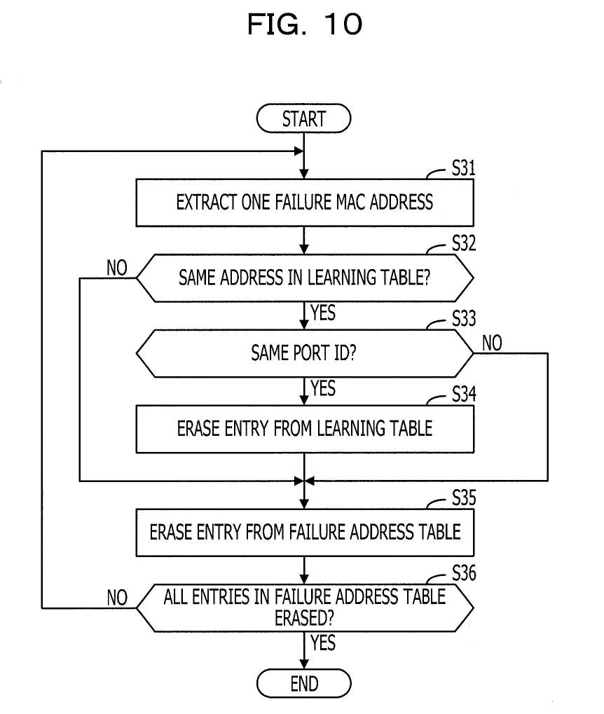

FIG. 10 is a flow chart illustrating a learning table update process according to the second embodiment. The processing illustrated in FIG. 10 will be described.

In S31, the table management unit 160 refers to the failure MAC address table 141 stored in the memory unit 140 to extract one entry including a MAC address and a corresponding port ID of a receiving port. For example, the table management unit 160 extracts an entry including the failure MAC address “A” and the port ID “P1”.

In S32, the table management unit 160 determines whether or not a MAC address that is the same as the failure MAC address extracted in S31 exists in the learning table 111 stored in the memory unit 110. The processing advances to S33 when such a MAC address exists therein. The processing advances to S35 when such a MAC address does not exist therein. For example, the table management unit 160 determines that an entry including a MAC address that is the same as the failure MAC address “A” exists in the learning table 111.

In S33, the table management unit 160 determines whether or not the port ID set in the entry including the MAC address in the learning table 111 matches the port ID of the receiving port extracted in S31. The processing advances to S34 when the port ID matches. The processing advances to S35 when the port ID does not match. For example, the port ID set in the entry including the MAC address “A” in the learning table 111 is “P1”. The port ID “P1” is extracted in S31, and thus the table management unit 160 determines that the ports match.

In S34, the table management unit 160 erases the entry including the MAC address from the learning table 111. For example, the table management unit 160 erases the entry including the failure MAC address “A” from the learning table 111.

In S35, the table management unit 160 erases the entry extracted in S31 from the failure MAC address table 141. For example, the table management unit 160 erases the entry including the failure MAC address “A”.

In S36, the table management unit 160 determines whether or not all the entries in the failure MAC address table 141 have been erased. The processing is completed when all the entries are erased. The processing returns to S31 when any entries remain.

In this way, the switch apparatus 100 attempts to erase an entry related to the MAC address in the failure MAC address table 141 from the learning table 111. The switch apparatus 100 erases an entry of the learning table 111 when the combination of the failure MAC address and the receiving port of the flush message 400 matches the combination of a MAC address and a port registered to the learning table 111.

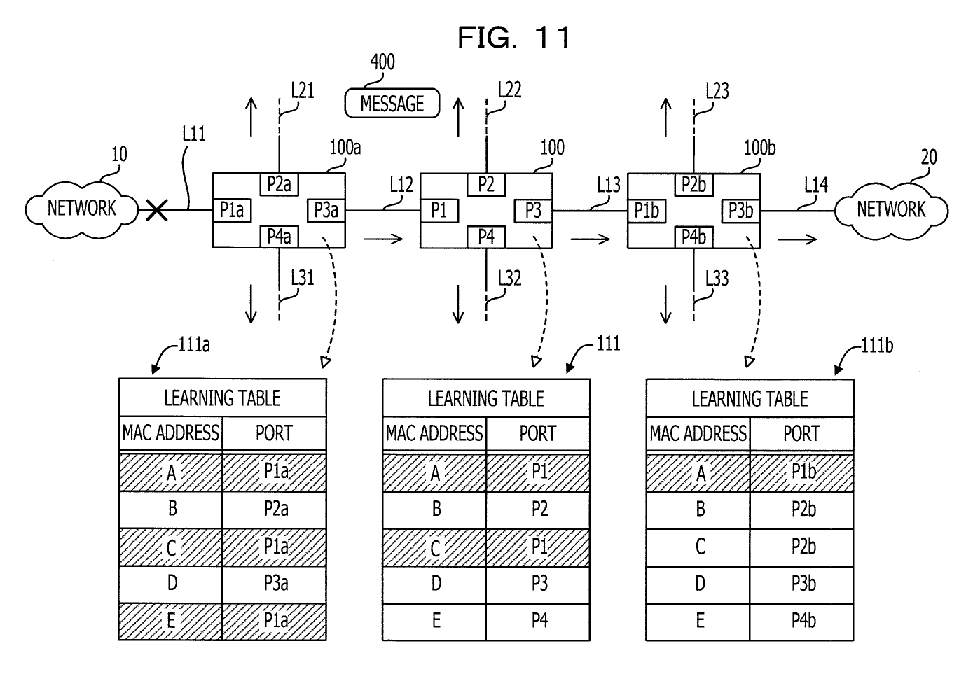

FIG. 11 illustrates an exemplary learning table update process according to the second embodiment. FIG. 11 depicts the ports of the switch apparatuses 100, 100a, and 100b. A port ID will be used to indicate each port in FIG. 11. For example, the port 101 is depicted as “P1” and referred to as port “P1”

The ports and the learning table 111 of the switch apparatus 100 are as described above.

The switch apparatus 100a includes ports “P1a”, “P2a”, “P3a”, and “P4a”. The port “P1a” is connected to the path L11. The port “P2a” is connected to the path L21. The port “P3a” is connected to the path L12. The port “P4a” is connected to the path L31. The switch apparatus 100a includes a learning table 111a.

The switch apparatus 100b includes ports “P1b”, “P2b”, “P3b”, and “P4b”. The port “P1b” is connected to the path L13. The port “P2b” is connected to the path L23. The port “P3b” is connected to the path L14. The port “P4b” is connected to the path L33. The switch apparatus 100b includes a learning table 111b.

For example, the switch apparatus 100a detects link down of the port “P1” due to a failure on the path L11. The switch apparatus 100a creates the flush message 400. The switch apparatus 100a includes in the flush message 400 the MAC addresses “A”, “C”, and “E” corresponding to the port “P1a” from the learning table 111a. The switch apparatus 100a floods the flush message 400. The switch apparatus 100a then erases the entries including the MAC addresses “A”, “C”, and “E” from the learning table 111a.

The switch apparatus 100 receives the flush message 400 from the switch apparatus 100a. The receiving port is the port “P1”. The switch apparatus 100 extracts the failure MAC addresses “A”, “C”, and “E” included in the flush message 400 and saves the MAC addresses along with the port ID of the receiving port in the failure MAC address table 141. The switch apparatus 100 then floods the flush message 400. The switch apparatus 100 then refers to the failure MAC address table 141 to erase the entries including the MAC addresses “A” and “C” from the learning table 111. The entry including the MAC address “E” is not erased since the port ID “P1” of the receiving port in the flush message 400 does not match the port ID “P4” in the entry of the learning table 111.

The switch apparatus 100b receives the flush message 400 from the switch apparatus 100. The receiving port is the port “P1b”. The switch apparatus 100b extracts the failure MAC addresses “A”, “C”, and “E” included in the flush message 400 and saves the MAC addresses along with the receiving port in a failure MAC address table in the same way as the switch apparatus 100. The switch apparatus 100b then floods the flush message 400. The switch apparatus 100b then refers to the failure MAC address table to erase the entry including the MAC address “A” from the learning table 111b. The entries including the MAC addresses “C” and “E” are not erased since the port ID “P1b” of the receiving port in the flush message 400 does not match the respective ports “P2b” and “P4b” in the entries of the learning table 111b.

The transmission timing of the flush message 400 in the above example will be described next. The following description refers to only the switch apparatuses 100, 100a, and 100b and the illustration of other apparatuses is omitted.

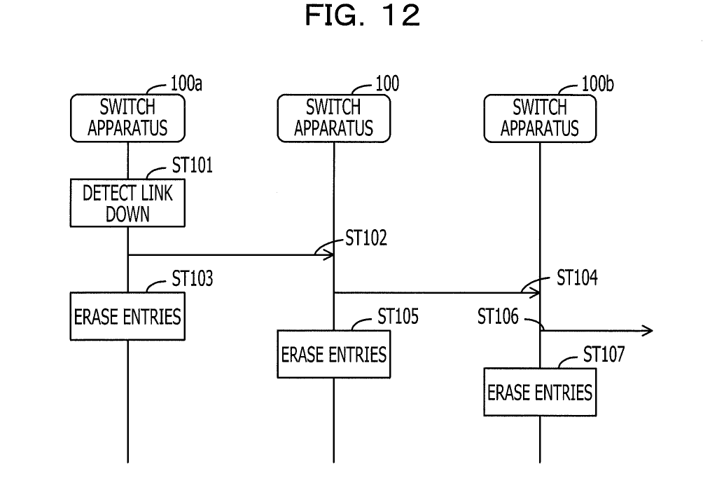

FIG. 12 is a sequence diagram illustrating an exemplary message transmission according to the second embodiment. The processing illustrated in FIG. 12 will be described.

In ST101, the switch apparatus 100a detects link down of the port “P1a”.

In ST102, the switch apparatus 100a creates the flush message 400 and conducts flooding. The switch apparatus 100 receives the flush message 400 from the switch apparatus 100a.

In ST103, the switch apparatus 100a then erases the entries including the MAC addresses “A”, “C”, and “E” corresponding to the port “P1a” from the learning table 111a.

In ST104, the switch apparatus 100 registers the failure MAC addresses “A”, “C”, and “E” included in the flush message 400 in association with in the memory unit 140. The switch apparatus 100 then floods the flush message 400. The switch apparatus 100b receives the flush message 400 from the switch apparatus 100.

In ST105, the switch apparatus 100 refers to the failure MAC address table 141 to erase the entries including the MAC addresses “A” and “C” from the learning table 111.

In ST106, the switch apparatus 100b registers the failure MAC addresses “A”, “C”, and “E” included in the flush message 400 in association with the port ID “P1b” of the receiving port in a failure MAC address table. The switch apparatus 100b then floods the flush message 400.

In ST107, the switch apparatus 100b refers to the failure MAC address table to erase the entry including the MAC address “A” from the learning table 111b.

In this way, the switch apparatuses 100, 100a, and 100b update the respective learning tables 111, 111a, and 111b after flooding the flush message 400.

ST103 may be conducted concurrently with ST104 or after ST104. Similarly, ST105 may be conducted concurrently with ST106 or after ST106.

Next, another example of transmission timing of the flush message 400 will be described. In example described hereinbelow, the switch apparatuses 100, 100a, and 100b flood the flush message 400 after updating the respective learning tables 111, 111a, and 111b.

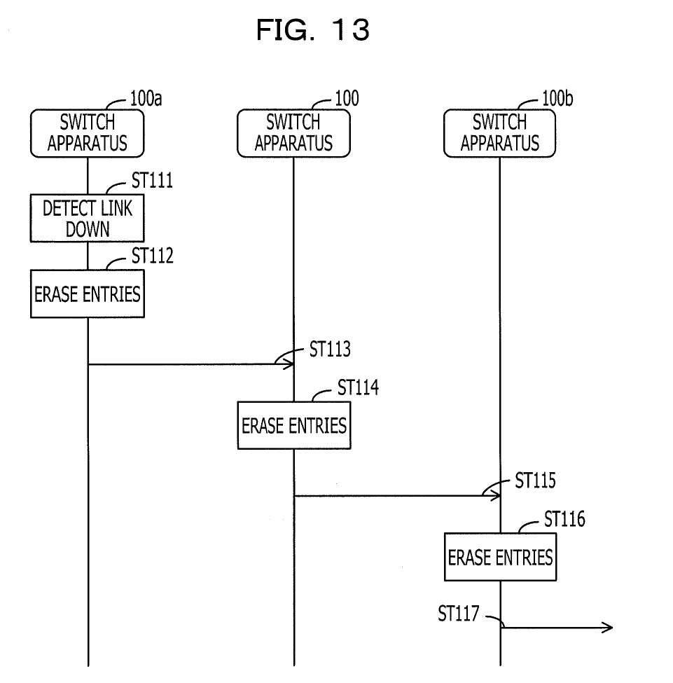

FIG. 13 is a sequence diagram illustrating another exemplary message transmission. The processing illustrated in FIG. 13 will be described.

In ST111, the switch apparatus 100a detects link down of the port “P1a”.

In ST112, the switch apparatus 100a erases the entries including the MAC addresses “A”, “C”, and “E” corresponding to the port “P1a” from the learning table 111a.

In ST113, the switch apparatus 100a creates the flush message 400 and conducts flooding. The switch apparatus 100 receives the flush message 400 from the switch apparatus 100a.

In ST114, the switch apparatus 100 erases certain entries from the learning table 111 based on the failure MAC addresses included in the flush message 400.

In ST115, the switch apparatus 100 floods the flush message 400. The switch apparatus 100b receives the flush message 400 from the switch apparatus 100.

In ST116, the switch apparatus 100b erases certain entries from the learning table 111b based on the failure MAC addresses included in the flush message 400.

In ST117, the switch apparatus 100b floods the flush message 400.

In this way, when the switch apparatuses 100, 100a, and 100b flood the flush message 400 after updating the respective learning tables 111, 111a, and 111b, the timing of the flooding is delayed due to the update. In the case of FIG. 13 in comparison to FIG. 12, the delay in the timing of the flooding is particularly noticeable in apparatuses further away from the switch apparatus 100a that originally creates the flush message 400.

Therefore, the switch apparatuses 100, 100a, and 100b first record the failure MAC addresses as described above with reference to FIG. 12. The flush message 400 is flooded next. The learning tables 111, 111a, and 111b are then updated based on the recorded failure MAC addresses. In this way, a delay in the flooding timing may be easily reduced.

The switch apparatuses 100, 100a, and 100b record the port ID of the receiving port of the flush message 400 at this time. Thus, the entries of the learning tables 111, 111a, and 111b are erased when the combination of the failure MAC address and the port ID of the receiving port match the combinations registered in the learning tables 111, 111a, and 111b. This avoids erasure of information on an alternative path for the unusable path to the node having the failure MAC address.

A case has been exemplified in the second embodiment in which update of the learning tables 111, 111a, and 111b is conducted immediately after conducting the flooding. However, the update may also be conducted, for example, after a certain amount of time has elapsed after the flooding.

### Third Embodiment

Hereinbelow, a third embodiment will be described. The following description will mainly deal with points that are different from the second embodiment and points that are similar will be omitted from the description.

The second embodiment describes an example in which the learning table 111 stored in the memory unit 110 is updated immediately after the switch apparatus 100 floods the flush message 400. However, the switch apparatus 100 may update the learning table 111 with another method. The third embodiment describes a function to update the learning table 111 with a method that is different from the one used in the second embodiment.

A configuration of the information processing system according to the third embodiment is similar to the configuration of the information processing system according to the second embodiment illustrated in FIG. 2. The functional configuration and hardware configuration of the switch apparatuses according to the third embodiment are similar to the functional configuration and hardware configuration of the switch apparatus 100 according to the second embodiment as illustrated in FIGS. 3 and 4. The configurations are denoted in the third embodiment using similar reference numerals and names as used in the second embodiment.

Hereinbelow, operating procedures of an information processing system according to the third embodiment will be described. The processing upon failure detection in the third embodiment is similar to the processing upon failure detection according to the second embodiment as illustrated in FIG. 8. The processing upon message reception in the third embodiment is similar to the processing upon message reception according to the second embodiment as illustrated in FIG. 9.

The learning table update process according to the third embodiment is different from the learning table update process described in the second embodiment. The following is a description of the learning table update process. It is assumed that the learning table 111 illustrated in FIG. 6 is stored in the memory unit 110. It is assumed that the failure MAC address table 141 illustrated in FIG. 7 is stored in the memory unit 140.

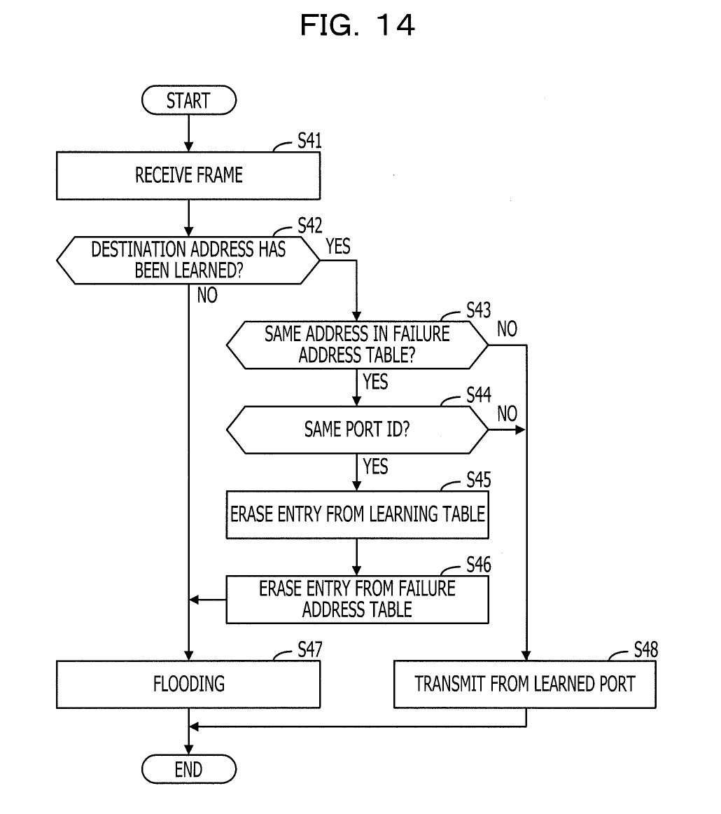

FIG. 14 is a flow chart illustrating a learning table update process according to the third embodiment. The processing illustrated in FIG. 14 will be described.

In S41, the communication control unit 120 receives a frame to be relayed and outputs the frame to the switching unit 104. It is assumed that the frame has been transmitted from the server apparatus 300 to the server apparatus 200. In this case, a destination MAC address is “A” and a source MAC address is “B” in the header of the frame.

In S42, the switching unit 104 determines, according to the learning table 111 stored in the memory unit 110, whether or not the destination MAC address has been learned. When the destination MAC address has been learned, the switching unit 104 passes the processing on to the table management unit 160 and the processing advances to S43. When the destination MAC address has not been learned, the processing advances to S47. For example, the entry including the source MAC address “A” is registered in the learning table 111. In this case, the switching unit 104 determines that the destination MAC address “A” has been learned.

In S43, the table management unit 160 determines whether or not the destination MAC address matches a failure MAC address in the failure MAC address table 141 stored in the memory unit 140. The processing advances to S44 when the MAC addresses match. The processing advances to S48 when the MAC addresses do not match. For example, an entry including the destination MAC address “A” is registered in the failure MAC address table 141. In this case, the table management unit 160 determines that the destination MAC address matches a failure MAC address.

In S44, the table management unit 160 determines whether or not the port IDs in the entries including the destination MAC address match in the learning table 111 and in the failure MAC address table 141. The processing advances to S45 when the port IDs match. The processing advances to S48 when the port IDs do not match. For example, the MAC address “A” and the port ID “P1” are included in an entry of the learning table 111. Furthermore, the failure MAC address “A” and the port ID “P1” of the receiving port are included in an entry of the failure MAC address table 141. In this case, the table management unit 160 determines that the port IDs in both entries match.

In S45, the table management unit 160 erases the entry including the destination MAC address from the learning table 111. For example, the table management unit 160 erases the entry including the MAC address “A” from the learning table 111.

In S46, the table management unit 160 erases the entry including the failure MAC address from the failure MAC address table 141. For example, the table management unit 160 erases the entry including the failure MAC address “A” from the failure MAC address table 141.

In S47, the communication control unit 120 floods the frame received in S41 to the ports other than the receiving port. The processing is then completed.

In S48, the switching unit 104 refers to the learning table 111 and notifies the communication control unit 120 about the learned port corresponding to the destination MAC address. The communication control unit 120 transmits the frame received in S41 from the learned port. The processing is then completed.

In this way, the switch apparatus 100 according to the third embodiment updates the learning table 111 at the timing of receiving a frame to be relayed.

The entry including the destination MAC address may be erased from the failure MAC address table 141 when it is determined that the port IDs do not match in S44.

The transmission timing of the flush message 400 in the above example will be described next. The following description refers to only the switch apparatuses 100, 100a, and 100b and the illustration of other apparatuses is omitted. The connection relationships between the paths and the ports of the switch apparatuses 100, 100a, and 100b are similar to the connection relationships illustrated in FIG. 11. The switch apparatuses 100, 100a, and 100b include the respective learning tables 111, 111a, and 111b.

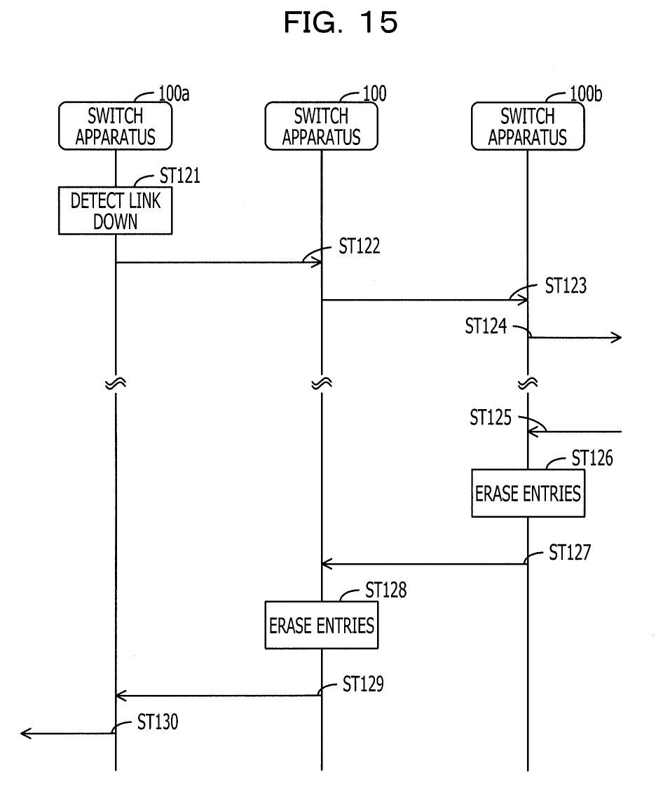

FIG. 15 is a sequence diagram illustrating an exemplary message transmission according to the third embodiment. The processing illustrated in FIG. 15 will be described.

In ST121, the switch apparatus 100a detects link down of the port “P1a”.

In ST122, the switch apparatus 100a creates a flush message 400 and conducts flooding. The switch apparatus 100 receives the flush message 400 from the switch apparatus 100a. The switch apparatus 100a erases the entries including the MAC addresses “A”, “C”, and “E” corresponding to the port “P1a” from the learning table 111a.

In ST123, the switch apparatus 100 registers the failure MAC addresses “A”, “C”, and “E” included in the flush message 400 in association with the port ID “P1” of the receiving port in the failure MAC address table 141 stored in the memory unit 140. The switch apparatus 100 then floods the flush message 400. The switch apparatus 100b receives the flush message 400 from the switch apparatus 100.

In ST124, the switch apparatus 100b registers the failure MAC addresses “A”, “C”, and “E” included in the flush message 400 in association with the port ID “P1b” of the receiving port in a failure MAC address table. The switch apparatus 100b then floods the flush message 400.

In ST125, the switch apparatus 100b receives a frame including the MAC address “B” of the server apparatus 300 as the source MAC address and the MAC address “A” of the server apparatus 200 as the destination MAC address.

In ST126, the switch apparatus 100b extracts the destination MAC address “A” included in the frame and determines that the MAC address “A” matches a failure MAC address registered in the failure MAC address table. Moreover, the switch apparatus 100b determines that the combination of the failure MAC address “A” and the port ID “P1b” of the receiving port included in an entry of the failure MAC address table matches the combination of the MAC address “A” and the port ID “P1b” included in an entry of the learning table 111b. The switch apparatus 100b erases the entry including the MAC addresses “A” from the learning table 111b. The switch apparatus 100b erases the entry including the MAC addresses “A” from the failure MAC address table.

In ST127, the switch apparatus 100b floods the frame received in ST125. The switch apparatus 100 receives the frame.

In ST128, the switch apparatus 100 extracts the destination MAC address “A” included in the frame and determines that the MAC address “A” matches a failure MAC address registered in the failure MAC address table 141. Moreover, the switch apparatus 100 determines that the combination of the failure MAC address “A” and the port ID “P1” of the receiving port included in an entry of the failure MAC address table 141 matches the combination of the MAC address “A” and the port ID “P1” included in an entry of the learning table 111. The switch apparatus 100 erases the entry including the MAC address “A” from the learning table 111. The switch apparatus 100 erases the entry including the MAC address “A” from the failure MAC address table 141.

In ST129, the switch apparatus 100 floods the frame received in ST127. The switch apparatus 100a receives the frame.

In ST130, the switch apparatus 100a extracts the destination MAC address “A” included in the frame. The switch apparatus 100a detects that no entry including the destination MAC address “A” exists in the learning table 111a (since the entry was erased in ST122). The switch apparatus 100a floods the frame.

In this way, the switch apparatuses 100 and 100b erase the entries of the MAC addresses from the respective learning tables 111 and 111b when relaying, after receiving and transmitting the flush message 400, a frame including the destination MAC address to be erased. As a result, a similar effect may be achieved as with the second embodiment.

The switch apparatus 100a updates the learning table 111a in ST122. Conversely, the switch apparatus 100a may update the learning table 111a upon receiving the frame to be relayed in ST129 in the same way as the switch apparatuses 100 and 100b.

In the third embodiment, the entry including the MAC address to be erased is not erased from the failure MAC address table 141 until a frame including, as the destination MAC address, the MAC address to be erased is received. In this case, a surplus of entries may remain in the failure MAC address table 141. The table management unit 160 then periodically erases the surplus entries from the failure MAC address table 141. For example, an aging timer of the learning table 111 may be used. The aging timer is a timer for managing a time limit (aging time) of registration for entries of the learning table 111.

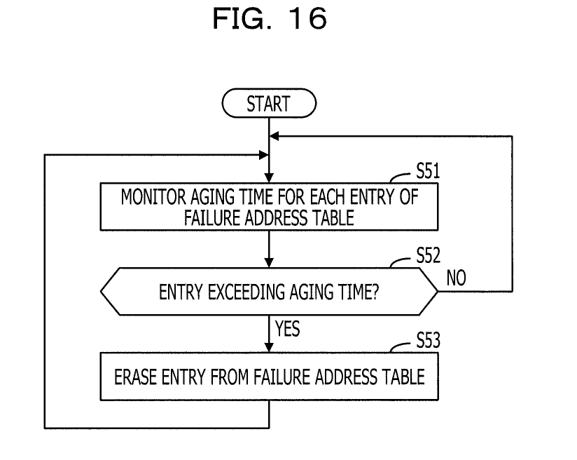

FIG. 16 is a flow chart illustrating aging management process according to the third embodiment. The processing illustrated in FIG. 16 will be described.

In S51, the table management unit 160 monitors the aging time for an entry of the failure MAC address table 141 stored in the memory unit 140. The aging timer for the entry is started, for example, when the entry is set in the failure MAC address table 141.

In S52, the table management unit 160 determines whether or not an entry exceeding the aging time exists. The processing advances to S53 when such an entry exists. The processing advances to S51 when such an entry does not exist.

In S53, the table management unit 160 erases the entry exceeding the aging time from the failure MAC address table 141. Then the processing advances to S51.

In this way, the switch apparatus 100 erases an entry of the failure MAC address table 141 when the aging time for the entry expires. A reason to use the aging timer of the learning table 111 is described below. Specifically, even if an entry is retained in the failure MAC address table 141 after expiration of the aging time, there may be a low possibility of receiving a frame including a destination MAC address corresponding to the entry. As a result, the possibility of updating the learning table 111 may be low by using the entry of the failure MAC address table 141 which has exceeded the aging time.

As a result, the possibility of a surplus of entries remaining in the failure MAC address table 141 is reduced and the memory 105b may be used more efficiently.

### Fourth Embodiment

Hereinbelow, a fourth embodiment will be described. The following description will mainly deal with points that are different from the second and third embodiments and points that are similar will be omitted from the description.

The second and third embodiments describe different processing methods for the switch apparatus 100 to update the learning table 111. Here, either of the processing methods to conduct the update may be specified. The fourth embodiment provides this function.

A configuration of the information processing system according to the fourth embodiment is similar to the configuration of the information processing system according to the second embodiment illustrated in FIG. 2. The functional configuration and hardware configuration of the switch apparatuses according to the fourth embodiment are similar to the functional configuration and hardware configuration of the switch apparatus 100 according to the second embodiment as illustrated in FIGS. 3 and 4. The configurations are denoted in the fourth embodiment using similar reference numerals and names as used in the second embodiment.

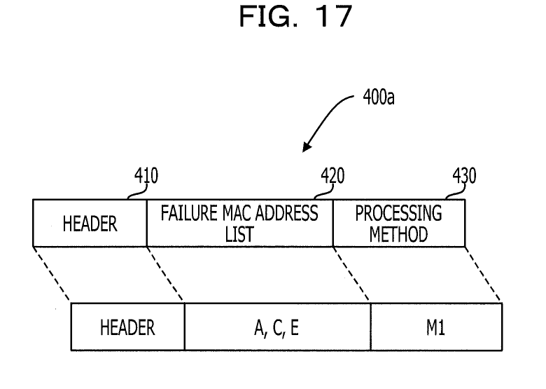

FIG. 17 illustrates an exemplary flush message according to the fourth embodiment. A flush message 400a includes fields of a header 410, a failure MAC address list 420, and a processing method 430.

The header 410 and the failure MAC address list 420 are described above with reference to FIG. 5.

The processing method 430 is a field that specifies a processing method for updating a learning table. The processing method is specified as described below.

(1) A processing method “M1” is a processing method to update the learning table in the order described in the second embodiment. Specifically, the processing method “M1” is a processing method to update the learning table immediately after flooding the flush message.

(2) A processing method “M2” is a processing method to update the learning table in the order described in the third embodiment. Specifically, the processing method “M2” is a processing method to update the learning table upon receiving a frame to be relayed after flooding the flush message.

When the processing method is not set (“NULL”), a default processing method that is set in each switch apparatus is used.

For example, it is assumed that the switch apparatus 100a detects a failure on the path L11. In this case, the switch apparatus 100a creates the flush message 400a and floods the flush message 400a to the paths L12, L21, and L31. The switch apparatus 100a includes the MAC addresses of the server apparatuses 200, 200a, and 200b connected to the path L11 in the failure MAC address list 420. The switch apparatus 100a sets the processing method 430 of the flush message 400a. Either of the processing methods “M1”, “M2”, and “NULL” is set previously in the switch apparatus 100a by an administrator of the information processing system.

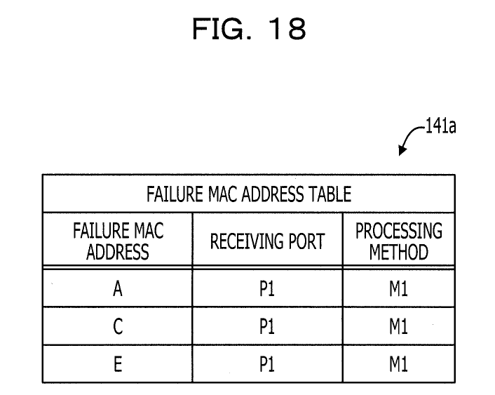

FIG. 18 illustrates an exemplary failure MAC address table according to the fourth embodiment. A failure MAC address table 141a is stored in the memory unit 140. The failure MAC address table 141a is provided with headings for a failure MAC address, a receiving port, and a processing method. Information arranged in a horizontal direction is associated with each other to form an entry corresponding to one node.

The contents set under the failure MAC address heading and the receiving port heading are described above with reference to FIG. 7. Which processing method is used to process the entry is set under the processing method heading.

The failure MAC address table 141a illustrates a case in which the switch apparatus 100 receives the flush message 400a from the switch apparatus 100a through the path L12. MAC addresses “A”, “C”, and “E” are set in the failure MAC address list 420 of the flush message 400a. The processing method “M1” is set for the processing method. In this example, an entry including the failure MAC address “A”, the receiving port “P1”, and the processing method “M1” is set in the failure MAC address table 141a. An entry including the failure MAC address “C”, the receiving port “P1”, and the processing method “M1” is also set in the failure MAC address table 141a. Moreover, an entry including the failure MAC address “E”, the receiving port “P1”, and the processing method “M1” is also set in the failure MAC address table 141a.

The following is a description of operating procedures of the information processing system with the above configuration. The processing upon failure detection in the fourth embodiment is similar to the processing upon failure detection according to the second embodiment as illustrated in FIG. 8. The switch apparatus 100a creates and transmits a flush message 400a in place of the flush message 400. The processing upon message reception in the fourth embodiment is similar to the processing upon message reception according to the second embodiment as illustrated in FIG. 9. However, the switch apparatus 100 stores, in the failure MAC address table 141a, contents of the processing method 430 of the flush message 400a.

According to the fourth embodiment, the switch apparatus 100 determines which processing method is used to update the learning table upon receiving the flush message 400a. Procedures for determining the processing method will be described next.

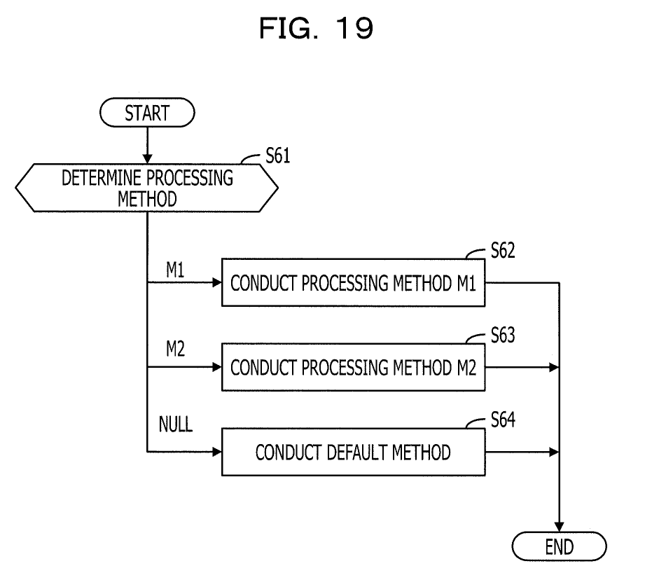

FIG. 19 is a flow chart illustrating processing to determine a processing method according to the fourth embodiment. The processing illustrated in FIG. 19 will be described.

In S61, the table management unit 160 refers to the failure MAC address table 141a stored in the memory unit 140 to determine the processing method for each entry. The processing advances to S62 when the processing method is “M1”. The processing advances to S63 when the processing method is “M2”. The processing advances to S64 when the processing method is “NULL”.

In S62, the table management unit 160 conducts the processing method “M1” on each entry. Specifically, the table management unit 160 updates the learning table 111 after the communication control unit 120 floods the flush message 400a. This procedure is conducted as described with reference to FIG. 10. The processing is then completed.

In S63, the table management unit 160 conducts the processing method “M2” on each entry. Specifically, the table management unit 160 updates the learning table 111 at a timing in which a frame relay occurs. This procedure is conducted as described with reference to FIG. 14. The processing is then completed.

In S64, the table management unit 160 conducts the default processing method as previously set in the switch apparatus 100. For example, either of the processing methods “M1” and “M2” is set previously in the switch apparatus 100 by the administrator of the information processing system. The processing is then completed.

In this way, the switch apparatus 100 is able to conduct the update of the learning table 111 according to any of a plurality of processing methods based on the flush message 400a. When a plurality of switch apparatuses exist, respective default processing methods of the switch apparatuses may be different. In this case as well, the processing method of the switch apparatuses may be easily unified by specifying the processing method using the flush message 400a.

Although the processing methods “M1” and “M2” have been exemplified, other processing methods may also be selected. For example, it is conceivable that a processing method may be used in which the learning table 111 is updated when a certain amount of time has elapsed after the flooding of the flush message 400a.

The second to fourth embodiments describe an L2 switch apparatus as the switch apparatuses 100, 100a, 100b, 100c, and 100d, but the embodiments are not limited as such. For example, a router apparatus or an L3 switch apparatus equipped with L2 switching functions may be applied with the functions described in the second to fourth embodiments.

A communication apparatus and a communication program have been described according to the illustrated embodiments herein. However, aspects of the embodiments are not limited as such and configurations of the units may be substituted by any configuration having similar functions. Furthermore, other arbitrary constituent parts or processes may be added to the embodiments. Moreover, the embodiments may include a combination of any two or more configurations (features) among the abovementioned embodiments.

The above processing functions may be implemented by a computer. In this case, the abovementioned processing contents of functions desired for the computer are provided by programs. The programs are implemented by the computer so that the abovementioned processing functions may be executed on the computer.

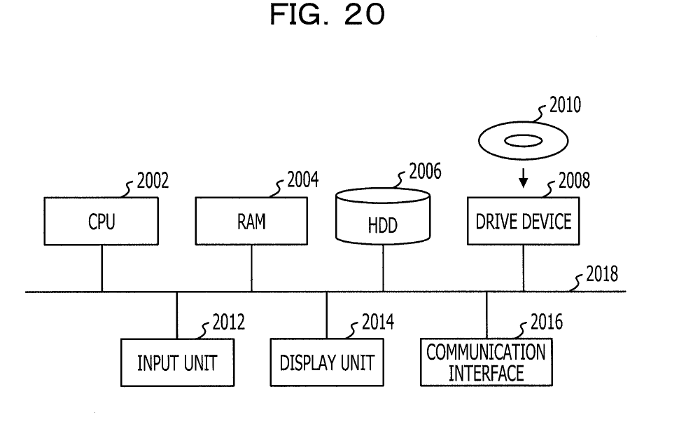

FIG. 20 illustrates an exemplary system configuration of the computer. The computer illustrated in FIG. 20 includes a central processing unit (CPU) 2002 for executing the software such as operating system (OS) and application programs, a random access memory (RAM) 2004 for temporarily storing data, a hard disk drive (HDD) 2006 for storing data, a drive unit 2008 for reading data from and/or writing data to a computer-readable medium 2010, an input unit 2012 for accepting user input, a display unit 2014 for displaying data, and a communication interface 2016 for establishing a connection to a network. These components are connected to one another via a bus 2018.

Programs including the processing contents may be recorded on a computer-readable medium. Computer-readable media include, for example, a magnetic storage device, an optical disk, a magneto-optic recording medium, a semiconductor memory and the like. The magnetic recording device may be a HDD, a flexible disk (FD), or a magnetic tape (MT) and the like. The optical disk may be a Compact Disc (CD), a Recordable/Rewritable CD (CD-R/RW), a Digital Versatile Disc (DVD), or a DVD-R/RW/RAM (random access memory). The magneto-optic recording medium may be a Magneto-Optical disk (MO). The semiconductor memory may be a flash memory such as a Universal Serial Bus (USB) memory and the like.

When the programs are distributed, the programs may be sold, for example, as programs recorded on a portable medium such as a DVD or a CD- ROM (read only memory) and the like. Furthermore, the programs may be stored in a server computer and transferred from the server computer to another computer through a network.

The computer that implements the programs may store the programs recorded on a portable medium or transferred from a server computer onto the computer's own storage device. The computer may then read the programs from the storage device and implement the processing according to the programs. The computer may read the programs directly from a portable medium and conduct processing according to the programs. Moreover, the computer may execute the processing according to programs sequentially transferred from the server computer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication apparatus comprising:
a plurality of communication ports;
a first memory unit;
a second memory unit to store address information, each entry of the address information including an address of a node in association with one of the plurality of communication ports; and
a processor to
receive a message including an address of an incommunicable node via a receiving port which is one of the plurality of communication ports,
store the received address in the first memory unit,
transmit the message via the plurality of communication ports other than the receiving port, and
erase a target entry of the address information from the second memory unit after the transmission, the target entry including an address which matches the address stored in the first memory unit.

2. The communication apparatus according to claim 1, wherein
the processor stores the received address in association with the receiving port in the first memory unit, and
the processor erases the target entry from the second memory unit when a communication port associated with the address included in the target entry matches the receiving port associated with the address stored in the first memory unit.

3. The communication apparatus according to claim 1, wherein
the processor erases from the second memory unit, upon receiving data having as a destination address the address stored in the first memory unit, the target entry including an address which matches the destination address.

4. The communication apparatus according to claim 1, wherein
the processor erases the address stored in the first memory unit after a predetermined time period has elapsed.

5. The communication apparatus according to claim 4, wherein
the predetermined time period is identical with an aging time of the address information.

6. The communication apparatus according to claim 1, wherein
the message includes procedure information regarding a procedure for erasing the target entry, and
the processor erases the target entry in accordance with the procedure information.

7. A computer-readable recording medium storing a program that causes a computer to execute a procedure, the procedure comprising:
receiving a message including an address of an incommunicable node via a receiving port which is one of a plurality of communication ports;
storing the received address in a first memory unit;
transmitting the message via the plurality of communication ports other than the receiving port; and
erasing a target entry of address information from a second memory unit after the transmission, the target entry including an address which matches the address stored in the first memory unit.
